(19) United States
(12) Patent Application Publication
(10) Pub. No.: US 2003/0206616 A1
(43) Pub. Date: Nov. 6, 2003

(54) Unlisted number call messaging

(76) Inventor: Richard L. Dowdy, Garland, TX (US)

Correspondence Address: WORLDCOM, INC., TECHNOLOGY LAW DEPARTMENT, 1133 19TH STREET NW, WASHINGTON, DC, 20036, US

(21) Appl. No.: 10/135,439

(22) Filed: May 1, 2002

(51) Int. Cl. H04M 1/64

(52) U.S. Cl. 379/67.1

(57) ABSTRACT

If an individual maintains an unlisted number, it is difficult, or impossible, for an individual to get in touch with the unlisted party via the unlisted telephone number. However, through the use of an unlisted number call messaging service, a calling party is able to leave a message for an unlisted party. In particular, the calling party leaves a message for the unlisted party. The message is associated with the unlisted party and the unlisted party is notified of the message via a predetermined procedure. The unlisted party, upon receipt of the message notification, then has the option to, for example, review the message.

### BACKGROUND OF THE INVENTION

1. Field of the Invention

The present invention generally relates to providing communication services, and more particularly, to providing a service for a user to leave a message for a party with an unlisted number.

2. Description of Related Art

Historically, telephone users have had two options for disclosing information about their telephone number. First, a user can have a telephone number, and various information such as address information, name, or the like, published in, for example, a telephone directory. Alternatively, a user can opt to have their telephone number “unlisted,” in which case the number is not publicly available.

Therefore, when a caller attempts to acquire a telephone number associated with an individual, there are two possible outcomes. In the first, a caller contacts, for example, an operator or automatic directly service and specifies, for example, the city, state and name of the individual for which the telephone number is desired. The operator or automatic service then retrieves the number associated with the individual and forwards the number to the caller, or alternatively, directly connects the caller to that individual, or a combination thereof.

Alternatively, if a caller requests a telephone number for an individual who has requested their telephone number remain unlisted, the operator or automatic directory service informs the user that the telephone number is not available.

### SUMMARY

Since the caller is unable to secure the telephone number of the unlisted party, the caller is unable to establish contact with the unlisted party. However, it would be desirable for the caller to be able to establish communication with the unlisted party, while at the same time maintaining the anonymity of the unlisted party.

Accordingly, and in accordance with an exemplary embodiment of this invention, a service is provided that allows one or more messages to be left for an unlisted party. This message can be left for the unlisted party without disclosing the unpublished party's number to the calling party. The message can be forwarded to the unlisted party where, for example, the unlisted party chooses whether to retrieve the message and/or return the call.

For example, either a live operator or an automated process can allow the messaging systems and methods of this invention to be implemented. For example, a calling party could call an operator and/or automated directory service requesting number information about a particular party. The operator and/or automated directory service could inform the calling party that they are attempting to reach an individual who has an unlisted number. At this point, the calling party would be given the opportunity to leave a message. If the calling party opts to leave a message, the operator or automated directory service could assist the caller with recording a message and forwarding the message or an indicator thereof to the unlisted party.

Thus, an exemplary feature of this arrangement is that a calling party could communicate with an unlisted party while maintaining the anonymity of the unlisted party.

Furthermore, another exemplary feature of this arrangement is that a calling party is able to communicate with an unlisted party where previously communication has not been available.

Aspects of the present invention relate to communications services. In particular, systems and methods are disclosed that allow a calling party to communicate with an unlisted party.

Aspects of the present invention also relate to messaging services for one or more of a calling party and unlisted party.

Aspects of the present invention also relate to systems and methods for providing messaging service to an unlisted party.

Aspects of the present invention also relate to notifying an unlisted party that a message has been received.

Aspects of the present invention also relate to allowing an unlisted party to manipulate a received message.

Aspects of the present invention additionally relate to forwarding information regarding a calling party to an unlisted party.

These and other features and advantages of this invention are described in or are apparent from the following detailed description of the embodiments.

### BRIEF DESCRIPTION OF THE DRAWINGS

The embodiments of the invention will be described in detail, with reference to the following figures wherein:

FIG. 1 is a functional block diagram illustrating an exemplary telecommunications network according to this invention;

FIG. 2 is a functional block diagram illustrating communications flow within the exemplary telecommunications network according to this invention;

FIG. 3 is a flow chart illustrating an exemplary method of leaving a message for an unlisted party according to this invention;

FIG. 4 is a flow chart outlining in greater detail the billing process according to this invention; and

FIG. 5 is a flow chart illustrating an exemplary method of notifying an unlisted party according to this invention.

### DETAILED DESCRIPTION

The exemplary systems and methods of this invention allow a calling party to leave a message for an unlisted party. In particular, and in accordance with an exemplary embodiment of this invention, upon a calling party learning that the party they are attempting to contact has an unlisted number, the calling party has the option of leaving a message for the unlisted party. If the calling party leaves a message, the unlisted party is notified that a message is waiting, and can be retrieved for playback, review, forwarding, or the like.

The exemplary systems and methods of this invention work equally well with both a live operator and an automated directory service system. In either case, upon determining that the phone number of the party that the calling party is attempting to contact is unlisted, the systems and methods of this invention are capable of invoking the messaging service that allows messages to be forwarded to an unlisted party while maintaining the anonymity of the unlisted party.

While the exemplary embodiments illustrated herein show the various components of the unlisted number call messaging system collocated, it is to be appreciated that the various components of the unlisted number call messaging system can be located at distant portions of a distributed network, such as a local area network, a wide area network, a telecommunications network, and intranet and/or the Internet or within a dedicated unlisted number call messaging system. Thus, it should be appreciated that the components of the unlisted number call messaging system can be combined into one or more devices or co-located on a particular node of a distributed network, such as a telecommunications network. As will be appreciated from the following description, and for reasons of computational efficiency, the components of the unlisted number call messaging system can be arranged at any location within a distributed network without affecting the operation of the system.

Furthermore, it should be appreciated that the various links connecting the elements can be wired or wireless links, or a combination thereof, or any known or later developed element(s) that is capable of supplying and/or communicating data to and from the connected elements.

Additionally, it should be appreciated that while various functional components are illustrated, various other components, such as exchange switches, long distance carriers, or the like can also be included without affecting the operation of the unlisted number call messaging system.

Also, the systems and methods of this invention can be applied with equal success to other type of communications where all or a portion of information is restricted from the calling party. For example, other types of communication and communications protocols include voice-over packet, voice-over IP (VOIP), voice over network, wired or wireless communications systems, such as cellular phones, PDA's, or the like. In general, the systems and methods of this invention will work with any communications system or protocol where a calling party has limited access to information about the called party.

Likewise, while the exemplary embodiments are discussed in relation to unlisted parties where a phone number is restricted from calling party access, and the option of leaving a voice message provided, alternatives to voice messaging are possible. For example, an e-mail address, internet protocol (IP) address, post office box address, uniform resource locator (URL), pager number, or the like, could be provided to the calling party as optional contact information for the called party. This information could then be used, in lieu of or in addition to the messaging service, for the calling party to contact the restricted party.

Generally speaking, a calling party requests, for example via an intelligent services network, a telephone number associated with a party. If the result of the directory number look-up indicates that the number is unlisted, the intelligent services network determines whether messaging services are available for the unlisted party. If messaging services are available, the intelligent services network informs the calling party of the option to leave a message for the unlisted party. If the calling party leaves a message, the intelligent services network records the message and forwards an indicator to the unlisted party indicating a message has been left. The unlisted party is then able to retrieve and/or further manipulate the message.

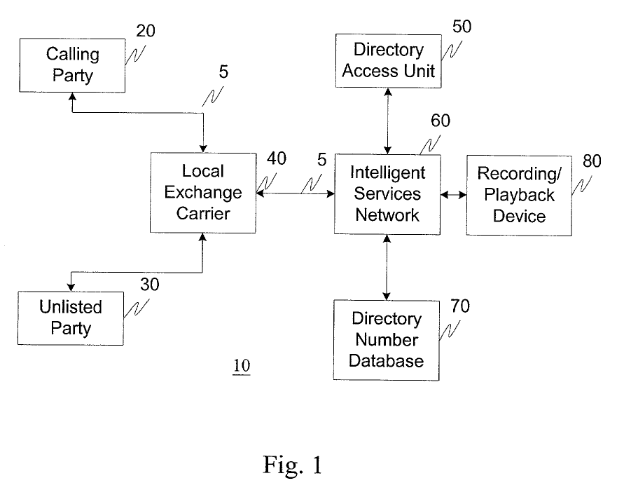

FIG. 1 illustrates a first exemplary embodiment of the unlisted number call messaging system 10. In particular, the unlisted number call messaging system 10 comprises a calling party 20, an unlisted party 30, a local exchange carrier 40, a directory access unit 50, an intelligent services network 60, a directory number database 70, and a recording/playback device 80, all interconnected by links 5.

In operation, a calling party 20, via the local exchange carrier 40, accesses the intelligent services network to determine the telephone number of a party. The intelligent services network 60 queries the directory number database 70 to determine the number for the requested party. If the number is available, the intelligent services network 60 provides the telephone number to the calling party 20. However, if the requested number is unlisted, the intelligent services network 60 determines if unlisted number call messaging is available for the unlisted party. If unlisted number call messaging is available for the unlisted party 30, the intelligent services network 60 informs the calling party 20 that they can leave a message for the unlisted party 30. If the calling party 20 opts to leave a message for the unlisted party 30, the intelligent services network 60, in conjunction with the directory access unit 50 and the recording/playback device 80, records the message of the calling party. Additionally, the intelligent services network 60 can also associate with the recorded message additional information, such as caller identification information of the calling party 20. Upon concluding recording of the message, the calling party 20 is disconnected from the intelligent services network 60.

The intelligent services network 60, via link 5 and the local exchange carrier 40, notifies the unlisted party 30 that a message is waiting. The unlisted party 30 communicates with the intelligent services network 60 which in turn, with the cooperation of the directory access unit 50, accesses the message stored in the recording/playback device 80. The unlisted party 30 can then review, replay, forward, or the like, the recorded message.

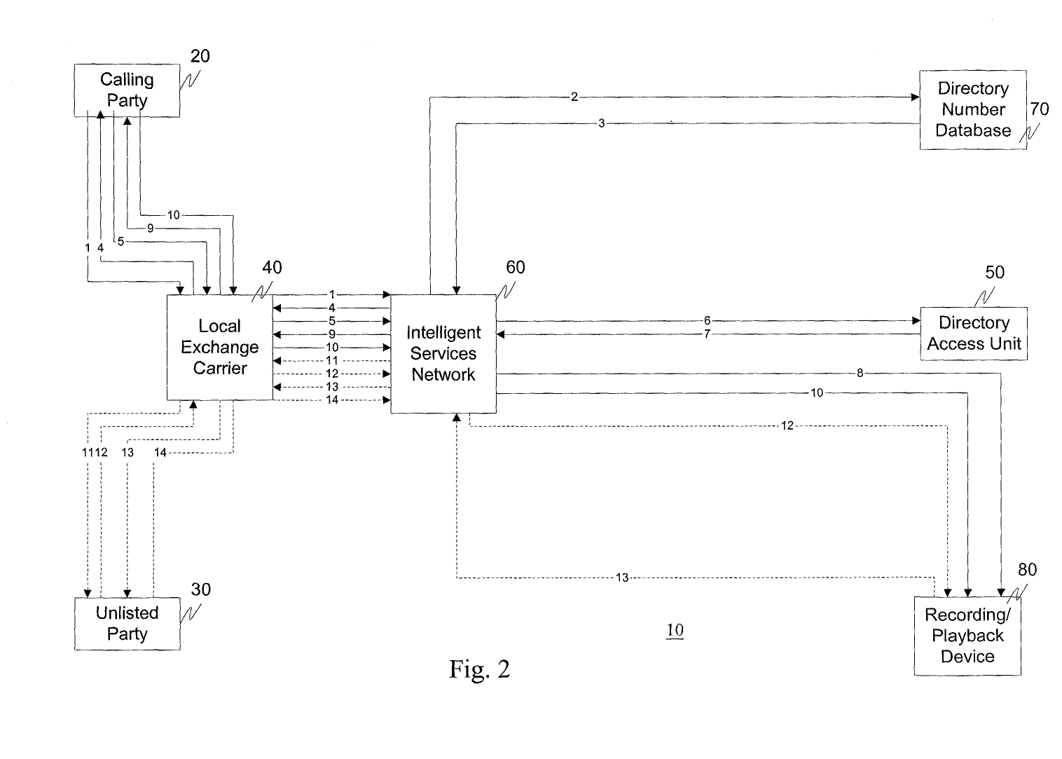

FIG. 2 outlines the operational flow of the unlisted number call messaging system 10 according to an exemplary embodiment of this invention. In particular, in step 1, the calling party 20, via the local exchange carrier 40, contacts the intelligent services network 60 requesting a telephone number of a party. The intelligent services network 60, in step 2, contacts the directory number database 70 to determine if a phone number is associated with the requested party. If a phone number is associated with the requested party, in step 3, the directory number database 70 returns the telephone number to the intelligent services network 60. The intelligent services network 60 then determines whether the telephone number received from the directory number database 70 is an unlisted number. If the number is not unlisted, the intelligent services network 60, in step 4, returns the telephone number of the requested party to the calling party 20. Alternatively, if the telephone number is unlisted, the intelligent services network 60, in step 4, returns a message to the calling party 20, via local exchange carrier 40, that the number is unlisted. Additionally, the intelligent services network 60 informs the calling party 20 whether unlisted number call messaging is available for the unlisted party.

Assuming that unlisted number call messaging is available, if the calling party 20 opts to leave a message for the unlisted party 30, the calling party 20, in step 5, notifies the intelligent services network 60. The intelligent services network 60, upon receiving the request to leave a message from the calling party 20, accesses the directory access unit 50 in step 6. The directory access unit 50 identifies, in step 7, a storage location for the message. The intelligent services network 60 then communicates, in step 8, with the recording/playback device 80, and prompts the calling party 20, in step 9, to commence recording of the message. In step 10, the calling party 20 forwards the message to the recording/playback device 80. Upon completion of the message, the calling party 20, with the assistance of the intelligent, services network 60, is disconnected from the recording/playback device 80.

Next, the intelligent services network 60, in step 11, communicates to the unlisted party 30 that a message is waiting. The unlisted party 30, in step 12, accesses the recording/playback device 80 to commence playback of the message. Then, in step 13, the recorded message is forwarded to the unlisted party 30.

At any time during playback of the message, or after completion of the message playback, in step 14, the unlisted party 30 has the option of manipulating the message stored in the recording/playback device 80. This can include forwarding, reviewing, replying, or the like.

For example, the intelligent services network 60 is also capable of associating additional information with the message stored in the recording/playback device 80. For example, the intelligent services network 60 can associate the number from which the calling party 20 was calling when the message was left. Then, upon the unlisted party 30 receiving the message, the unlisted party 30 could also be given the telephone number from which the message was left and the option of, for example, automatically dialing the number associated with the calling party 20.

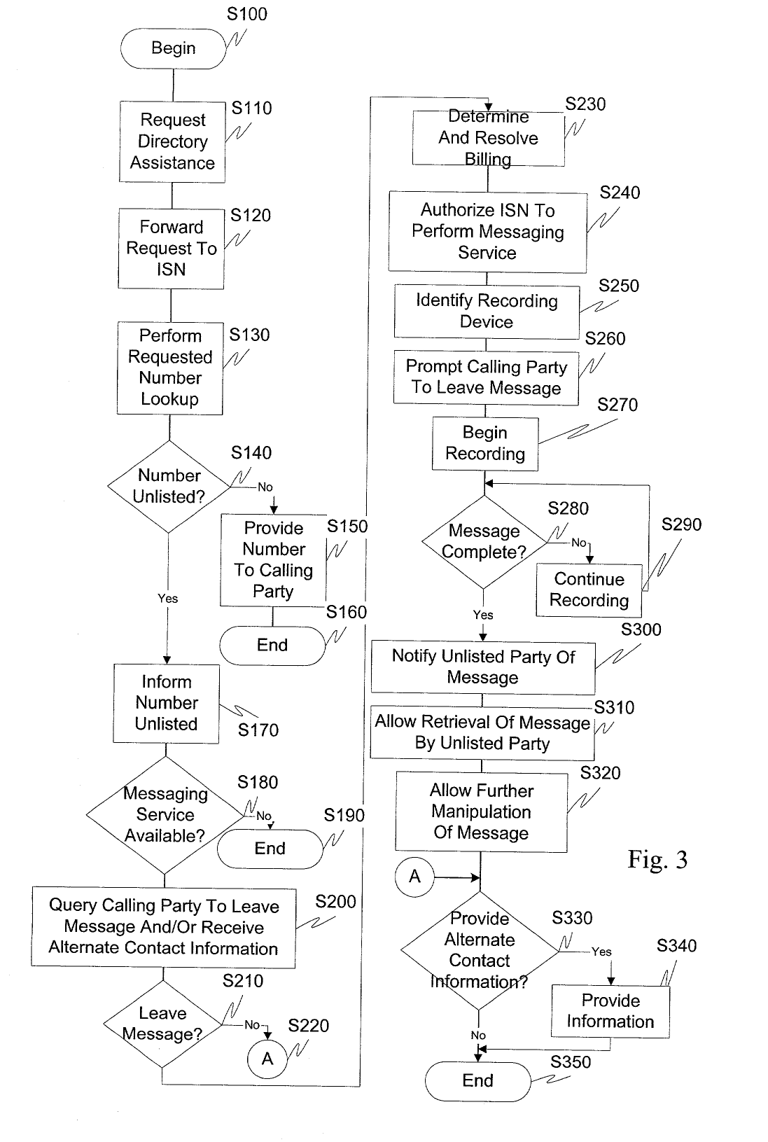

FIG. 3 outlines an exemplary embodiment for unlisted number call messaging. In particular, control begins in step S100 and continues to step S110. In step S110, a calling party requests directory assistance. Next, in step S120, the request for directory assistance is forwarded to the intelligent services network. Then, in step S130, an attempt is made to retrieve a number associated with the requested information. Control then continues to step S140.

In step S140, a determination is made as to whether the number is unlisted. If the number is not unlisted, control continues to step S150. Otherwise, control jumps to step S170.

In step S150, the number associated with the requested information is provided to the calling party. Control then continues to step S160, where the control sequence ends.

In step S170, the calling party is informed that the requested number is unlisted. Next, in step S180, a determination is made as to whether the unlisted number call messaging/contact information providing service is available for the unlisted party. If the unlisted number call messaging service is not available, control continues to step S190, where the control sequence ends. For example, the called part may not subscribe, or be unwilling to pay, for the messaging service. In this instance, the calling party may not have the option of leaving a message. Alternatively, the calling party may always have the option of leaving a message, with the retrieval of the message being left up to the discretion of the called party. Alternatively still, this determination can be based on whether one or more of the parties is capable of paying for the service. Otherwise, control jumps to step S200, where the calling party is prompted to leave a message and/or receive contact information.

In step S210, a determination is made as to whether the calling party desires to leave a message. If the calling party does not desire to leave a message, control continues to step S220, where control jumps to step S330. Otherwise, control jumps to step S230.

In step S230, billing issues are resolved. For example, the calling party can be billed a first rate for leaving a message, a second rate for receiving contact information, a third rate for both, or some combination thereof. Next, in step S240, the intelligent services network is authorized to perform the messaging service. Then, in step S250, a recording device is identified to store the message. Control then continues to step S260.

In step S260, the calling party is prompted to leave a message. Next, in step S270, the calling party begins recording. Then, in step S280, a determination is made as to whether the calling party's message is complete. If the calling party's message is not complete, control continues to step S290, where recording continues. Control then jumps back to step S280. Otherwise, control jumps to step S300.

In step S300, the unlisted party is notified that a message has been left. For example, a predetermined or custom ring sequence can be sent to the unlisted parties number. Alternatively, a light or other visual or audio que can be sent to the unlisted party to indicate a message has been left. Next, in step S310, the message can be retrieved by the unlisted party. Then, in step S320, the message and be further manipulated, such as forwarded or deleted, by the called party. Control then continues to step S330.

In step S330, the calling party is prompted whether alternate restricted party contact information is desired. If alternate contact information is desired and available, all or a portion of the contact information is provided in step S340. Additionally, as discussed above, billing issues can be resolved before providing the contact information. For example, the calling party can be billed a first rate for leaving a message, which may further be based on the type of message such as numeric or voice, a second rate for receiving contact information, a third rate for both, a fourth rate for the type of requested contact information, or some combination thereof. If the intelligent services network authorizes the providing of contact information, the calling party can, for example, be prompted to select from a plurality of types of contact information and/or receive all of the contact information that is available. For example, the contact information can be associated with the directory number database and played by the intelligent services network to the calling party. Alternatively, for example, if the calling party is calling from a telephone associated with a display, all or a portion of the contact information can be displayed to the calling party. Control then continues to step S350, where the control sequence ends.

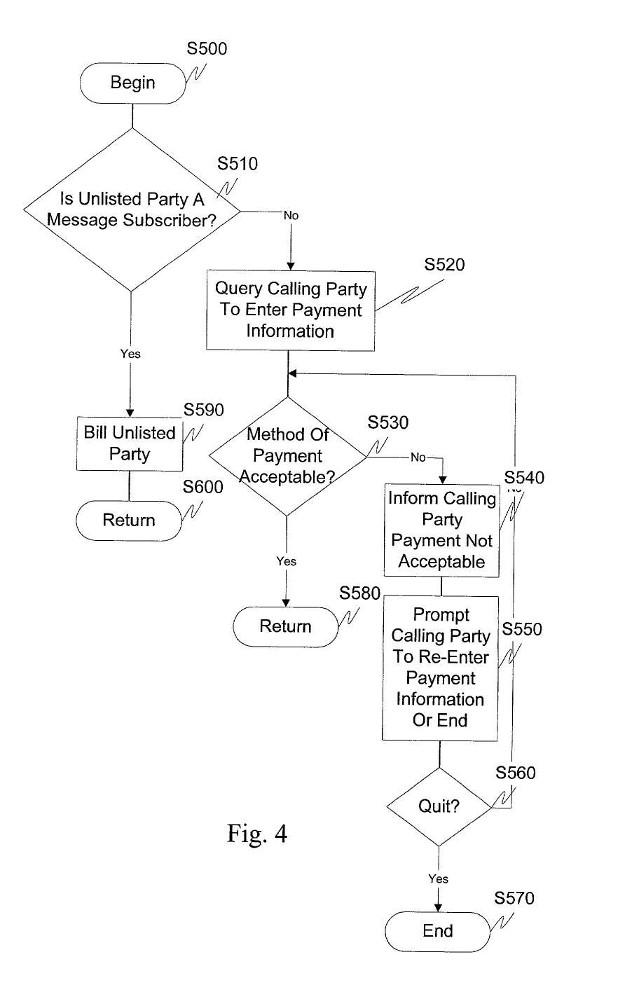

FIG. 4 outlines in greater detail the billing step of FIG. 3. In particular, control begins in step S500 and continues to step S510. In step S510, a determination is made as to whether the unlisted party is an unlisted number call messaging subscriber. If the unlisted party is not an unlisted number call messaging subscriber, control continues to step S520. Otherwise, control jumps to step S590.

In step S520, the calling party is queried to enter payment information. For example, payment forms can include calling cards, credit cards, cash inserted into a pay phone, billing to a home phone number, or the like. Next, in step S530, a determination is made as to whether the entered method of payment is acceptable. If the entered method of payment is not acceptable, control continues to step S540. Otherwise, control jumps to step S580, where control returns to the authorizing step.

In step S540, the calling party is notified that the entered payment information is not acceptable. Next, in step S550, the calling party is prompted to reenter payment information or to quit. Then, in step S560, a determination is made as to whether the calling party has requested to quit the unlisted number call messaging service. If the calling party opts to re-enter payment information, control jumps back to step S530. Otherwise, control continues to step S570, where the control sequence ends.

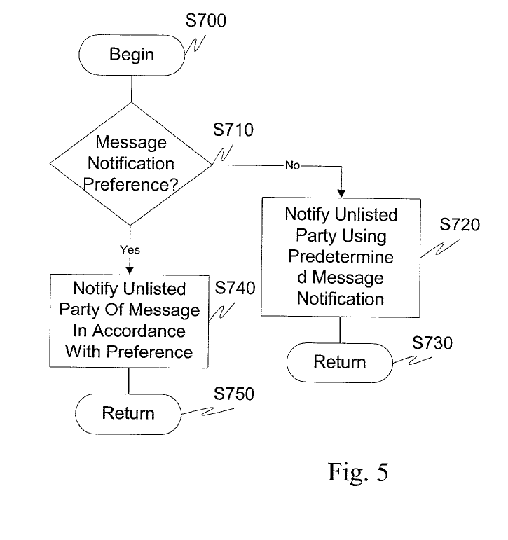

FIG. 5 outlines in greater detail the notification step of FIG. 3. In particular, control begins in step S700 and continues to step S710. In step S710, a determination is made as to whether a message notification preference is associated with the unlisted party. If a message notification preference is not associated with the unlisted party, control continues to step S720. In step S720, the unlisted party is notified using a predetermined or custom message notification. Control then continues to step S730, where the control sequence returns to step S310.

In step S740, the intelligent services network retrieves a profile associated with the unlisted party and notifies the unlisted party in accordance with the unlisted party's preference. Control then continues to step S750 where the control sequence returns to step S300.

For example, the profile associated with the unlisted party can indicate that the phone should ring once, a light, or other audio/visual que should be forwarded to the phone, or, alternatively, for example, the message should be forwarded to a predetermined destination, such as a cell phone, alternate number, or the like.

Similarly, the unlisted party can, for example, automatically have the calling party's phone number dialed upon receipt of a message from a calling party, or other function that can be stored in the unlisted party's profile.

As illustrated in the figures, the unlisted number call messaging system can be implemented either on a single programmed general purpose computer, a separate programmed general purpose computer, or a combination thereof. However, the unlisted number call messaging system can also be implemented on a special purpose computer, a programmed microprocessor or microcontroller and peripheral integrated circuit elements, an ASIC, or other integrated circuit, a digital signal processor, a hard-wired electronic or logic circuit, such as a discrete element circuit, a programmable logic device such as a PLD, PLA, FPGA, PAL, or the like. In general, any device capable of implementing a state machine that is, in turn, capable of implementing the flow charts illustrated in FIGS. 3-5 can be used to implement the unlisted number call messaging system according to this invention.

Furthermore, the disclosed method may be readily implemented in software using an object or object-oriented software development environment that provides source code that can be used on a variety of computer, server, or workstation hardware platforms. Alternatively, the disclosed unlisted number call messaging system may be implemented partially for fully in hardware using standard logic circuits, or VLSI design. Whether software or hardware is used to implement the systems in accordance with this invention is dependent on the speed and/or efficiency requirements for the system, their particular function, and the particular software or hardware systems or microprocessor or microcomputer and telecommunication systems being utilized. The unlisted number call messaging system illustrated herein, however, can be readily implemented in hardware and/or software using any known or later developed systems or structures, devices, and/or software by those of ordinary skill in the applicable art from the functional description provided herein, and with a general basic knowledge of the computer and telecommunications arts.

Moreover, the disclosed methods may be readily implemented as software executed on a programmed general purpose computer, a special purpose computer, a microprocessor, or the like. In these instances, the methods and systems of this invention can be implemented as a program embedded in a telecommunications systems, such as a JAVA®, or CGI script, as a resource residing on a server or graphics workstation, as a routine embedded in a dedicated unlisted number call messaging system, or the like. The unlisted call number messaging system can also be implemented by physically incorporating the system into a software and/or hardware system such as the hardware and software system of a server and associated telecommunications management/switching device(s).

It is, therefore, apparent that there has been provided, in accordance with the present invention, systems and methods for unlisted number call messaging. While this invention has been described in conjunction with a number of embodiments, it is evident that many alternatives, modifications, and variations would be or are apparent to those of ordinary skill in the applicable arts. Accordingly, the disclosure is intended to embrace all such alternatives, modifications, equivalents and variations that are within the spirit and scope of this invention.

What is claimed:

1. A messaging system for a restricted party comprising:
an intelligent services network; and
a messaging device associated with the intelligent services network, wherein a calling party can at least one of receive contact information and leave a message for the restricted party.

2. The system of claim 1, wherein the restricted party is at least one of an unlisted party and a called party for which limited information is available.

3. The system of claim 1, wherein the contact information includes at least one of an e-mail address, an internet protocol (IP) address, a post office box address, a uniform resource locator (URL) and a pager number.

4. The system of claim 1, further comprising a directory access unit that associates the message from the calling party with a storage location corresponding to the restricted party in a message storage device.

5. The system of claim 1, wherein at least one of the calling party and the restricted party are billed.

6. The system of claim 5, wherein the calling party can pay with one or more of a calling card, a credit card, cash and a home billing number.

7. The system of claim 1, wherein the intelligent services network notifies the restricted party when the message is received.

8. The system of claim 7, wherein the notification is performed in accordance with at least one of a predetermined and custom notification.

9. The system of claim 8, wherein the custom notification is based on a profile associated with the restricted party.

10. The system of claim 1, wherein additional information is associated with the message.

11. The system of claim 10, wherein the additional information is at least one of caller identification information, time information, date information and billing information.

12. The system of claim 1, wherein the intelligent services network allows the restricted party to at least one of retrieve, review, forward and delete the message.

13. The system of claim 1, wherein a phone number of the restricted party is not disclosed to the calling party.

14. A method of contacting a restricted party comprising:
receiving a query from a calling party requesting information about the restricted party; and
providing at least one of contact information and a messaging service to the calling party, wherein the messaging service can leave a message for the restricted party.

15. The method of claim 14, wherein the restricted party is at least one of an unlisted party and a called party for which limited information is available.

16. The method of claim 14, wherein the contact information includes at least one of an e-mail address, an internet protocol (IP) address, a post office box address, a uniform resource locator (URL) and a pager number.

17. The method of claim 14, further comprising associating the message from the calling party with a storage location corresponding to the unlisted party.

18. The method of claim 14, wherein at least one of the calling party and the restricted party are billed for the messaging service.

19. The method of claim 18, wherein the calling party can pay for the messaging service with one or more of a calling card, a credit card, cash, and a home billing number.

20. The method of claim 14, further comprising notifying the restricted party when the message is received.

21. The method of claim 20, wherein the notification is performed in accordance with at least one of a predetermined or custom notification.

22. The method of claim 21, wherein the custom notification is based on a profile associated with the restricted party.

23. The method of claim 14, wherein additional information is associated with the message.

24. The method of claim 23, wherein the additional information is at least one of caller identification information, time information, date information and billing information.

25. The method of claim 14, further comprising allowing the restricted party to at least one of retrieve, review, forward and delete the message.

26. The method of claim 14, wherein a phone number of the restricted party is not disclosed to the calling party.

27. An information storage media comprising information for contacting a restricted party comprising:
information that receives a query from a calling party requesting information about the restricted party; and
information that provides at least one of contact information and a messaging service to the calling party, wherein the messaging service can leave a message for the restricted party.

28. The media of claim 27, wherein the restricted party is at least one of an unlisted party and a called party for which limited information is available.

29. The media of claim 27, wherein the contact information includes at least one of an e-mail address, an internet protocol (IP) address, a post office box address, a uniform resource locator (URL) and a pager number.

30. The media of claim 27, further comprising information that associates the message from the calling party with a storage location corresponding to the unlisted party.

31. The media of claim 27, wherein at least one of the calling party and the restricted party are billed for the messaging service.

32. The media of claim 31, wherein the calling party can pay for the messaging service with one or more of a calling card, a credit card, cash, and a home billing number.

33. The media of claim 27, further comprising information that notifies the restricted party when the message is received.

34. The media of claim 33, wherein the notification is performed in accordance with at least one of a predetermined or custom notification.

35. The media of claim 34, wherein the custom notification is based on a profile associated with the restricted party.

36. The media of claim 27, wherein additional information is associated with the message.

37. The media of claim 36, wherein the additional information is at least one of caller identification information, time information, date information and billing information.

38. The media of claim 27, further comprising information that allows the restricted party to at least one of retrieve, review, forward and delete the message.

39. The media of claim 27, wherein a phone number of the restricted party is not disclosed to the calling party.

40. A method of billing for a messaging service comprising:
determining an identification of a calling party;
determining an identification of a restricted party;
receiving information identifying at least one of the calling party and the called party to whom the messaging service should be billed; and
arranging for debiting the identified party.
